(19) United States
(12) Patent Application Publication
(10) Pub. No.: US 2026/0093921 A1
(43) Pub. Date: Apr. 2, 2026

(54) Machine Learning Model-Based Entity Tracing

(71) Applicant: Disney Enterprises, Inc., Burbank, CA (US)

(72) Inventors: Francesc Josep Guitart Bravo, Barcelona (ES); Monica Alfaro Vendrell, Barcelona (ES)

(21) Appl. No.: 18/900,327

(22) Filed: Sep. 27, 2024

(51) Int. Cl. G06F 40/295; H04N 21/44

(52) U.S. Cl. CPC G06F 40/295; H04N 21/44008

(57) ABSTRACT

A system includes a hardware processor and an entity tracing engine including a first machine learning (ML) model trained as a mapping agent and a second ML model trained as a scoring agent. The hardware processor executes the entity tracing engine to receive content including at least one of an image, video, audio, or text, identify, using a feature analyzer, one or more entities referenced in the content, and map, using the mapping agent, each entity to respective one or more entries in a knowledge base to provide one or more entity mapping(s). The hardware processor further executes that entity tracing engine to determine, using the scoring agent, a relevance score for each of the entity mapping(s) relative to the content, and provide an output identifying the content, at least one of the entity mapping(s) and the relevance score for the at least one of the entity mapping(s).

### BACKGROUND

Media content can be rich in diverse entities, such as persons, organizations, logos or brands, and venues, for example, that are readily identifiable as such by humans, but that can pose a significant challenge for computers to identify because those entities may appear across multiple different media modalities within the same content (e.g., an athlete might be featured in a video, audio cue, and banner within the same sports video clip). For a stakeholder of an entity, it is often important to promptly identify and assess the descriptive metadata attributed to the entity by various sources, such as news outlets and social media platforms for example, due to the potential benefits of enhancing the reputation of the entity with accurate or laudatory metadata descriptors sourced externally, as well as to ensure timely correction or removal of erroneous or derogatory metadata tags.

Although there are existing methods for mapping entities to knowledge bases, most of these existing approaches operate in a unimodal fashion. The existing multimodal exceptions rely on specific rules manually prepared for particular domains, such as a particular sport or other distinct area of expertise. However, the reliance on specific rules imposes significant limitations. For example, such rules do not scale well with increasing amounts of knowledge or the analyzers used for identification of entities in media content. In addition, maintaining and updating rules can be challenging, as they tend to be tightly coupled to specific use cases, so that each new use case typically requires a unique set of rules that can be difficult to adapt and fine-tune to achieve satisfactory results. Consequently, there is a need in the art for an adaptable machine learning model-based approach that can effectively trace entities across various media content using multimodal information from diverse sources.

### BRIEF DESCRIPTION OF THE DRAWINGS

FIG. 1 shows a diagram of an exemplary system for performing machine learning (ML) model-based entity tracing, according to one implementation;

FIG. 2 shows an exemplary diagram of an entity tracing engine suitable for execution by a hardware processor of the system shown in FIG. 1, according to one implementation;

FIG. 3 shows a flowchart presenting an exemplary method for performing ML model-based entity tracing, according to one implementation; and

FIG. 4 shows a diagram depicting features detected in audio-visual content and used to trace an entity, according to one exemplary implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, although methods for mapping entities detected in media content, i.e., entities such as persons, organizations, logos or brands, and venues, for example, to descriptions of those entities stored in knowledge bases exist, most of these existing approaches operate in a unimodal fashion. As further noted above, existing multimodal exceptions to the unimodal norm rely on specific rules manually prepared for particular domains, such as a particular sport or other distinct area of expertise. However, and as also noted above, the reliance on specific rules imposes significant limitations. For example, such rules do not scale well with increasing amounts of knowledge or the analyzers used for identification of entities in media content. In addition, maintaining and updating rules can be challenging, as they tend to be tightly coupled to specific use cases, so that each new use case typically requires a unique set of rules that can be difficult to adapt and fine-tune to achieve satisfactory results.

The present application discloses systems and methods for performing machine learning (ML) model-based entity tracing that address and overcome the limitations in the conventional art described above. By way of overview, ML models such as large-language models (LLMs), and more generally multimodal foundation models, have demonstrated impressive abilities in contextual understanding, making them an attractive alternative to traditional rule-based systems. By harnessing the power of LLMs and multimodal foundation models, the present application discloses a system that accurately maps entities referenced in media content to knowledge base entries, taking into account the context from multiple sources. This is particularly relevant when dealing with unstructured contexts, such as those found in brief descriptions of entities in some public knowledge bases that follow no pattern.

The present application introduces systems and methods that use a novel and inventive entity tracing engine including a mapping agent, which, as defined herein, is a pre-trained, fine-tuned, or prompt-engineered LLM or multimodal foundation model that links entities referenced in media content to corresponding knowledge base entries to provide entity mappings. The entity tracing engine also includes a scoring agent, which as defined herein is another pre-trained, fine-tuned, or prompt-engineered LLM or multimodal foundation model configured to rank and score the entity mappings provided by the mapping agent based on their predicted relevance to the media content in which the mapped entity is referenced.

For example, the relevance score of a mapped entity may depend on the number of times that the same entity is referenced in a piece of media content, the number of media modalities used to reference that same entity in the media content, or both. Thus, an entity referenced multiple times may be predicted to be more relevant, i.e., have a higher relevance score, relative to the media content referencing that entity, than another entity referenced fewer times. Alternatively, or in addition, an entity referenced using multiple media modalities, e.g., video, audio, text and the like, may be predicted to be more relevant, i.e., have a higher relevance score, relative to the media content referencing that entity, than another entity referenced using fewer media modalities. As another alternative, or in addition, the relevance score of a mapped entity may be determined using the context of the content in which the entity is referenced, as that context is understood by the LLM or multimodal foundation model of the scoring agent.

It is noted that LLMs and multimodal foundation models exhibit excellent capabilities in zero-shot learning and few-shot learning. Moreover, they can also be trained and fine-tuned over specific datasets, allowing the system disclosed in the present application to operate in an unsupervised manner as an automated system while still optimizing performance through token utilization or improving accuracy. As used in the present application, the terms “automation,” “automated” and “automating” refer to systems and processes that do not require the participation of a human system operator. Although in some implementations the performance of the systems and methods disclosed herein may be monitored or refined by a human system operator, that human involvement is optional. Thus, the methods described in the present application may be performed under the control of hardware processing components of the disclosed systems.

It is further noted that the expression “knowledge base” (hereinafter “KB”), as used herein, refers to the standard definition of that feature known in the art. Thus, in contrast to a simple database that includes discrete and independent data entries, a KB is a collection of organized information relevant to one or more subjects. In addition to individual entries describing specific aspects of the subject matter covered by a KB, the KB typically includes pointers or other linkages for navigating to related information within the KB. Examples of general subject-matter KBs include WIKIDATA®, the GOOGLE® Knowledge Graph, and the ASSOCIATED PRESS®.

Moreover, as defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as Transformers, LLMs, or multimodal foundation models, to name a few examples. In various implementations, ML models may be trained as classifiers and may be utilized to perform image processing, audio processing, natural-language processing, and other inferential analyses.

The use of LLMs or multimodal foundation models as mapping and scoring agents of the entity tracing engine disclosed herein has a direct impact on the accuracy of the system implementing that engine, as those models are trained on vast amounts of data and can learn patterns and relationships that may not be apparent to humans. Thus, the entity tracing techniques performed by the systems and using the methods disclosed in the present application are incapable of being performed by a human mind, even when aided by the resources of a general purpose computer. Moreover, this also means that even in domains where rules would require extensive manual tuning, an LLM-based or multimodal foundation model-based approach can produce accurate results with minimal additional effort. Furthermore, the maintenance of a system based on LLMs or multimodal foundation models is significantly easier than one relying on rules. With traditional rule-based systems, updates and changes often require manual rewriting of the rules, a process that can be tedious and prone to error. By contrast, an LLM-based or multimodal foundation model-based approach allows for straightforward retraining and updating of the model, ensuring that the system remains accurate and effective over time.

Additionally, the adaptability of an LLM-based and multimodal foundation model-based systems is unparalleled. Once trained on a particular domain, these models can be readily applied to other domains with minimal additional effort, making them an ideal solution for organizations with diverse needs. In contrast, rule-based systems are often limited to a single domain or require significant rework to apply to a new domain. Finally, while rules may be able to provide some level of accuracy in specific contexts, they are fundamentally unable to learn and improve over time. LLMs and multimodal foundation models, on the other hand, can be retrained and updated as new data becomes available, allowing them to continuously refine their performance and accuracy.

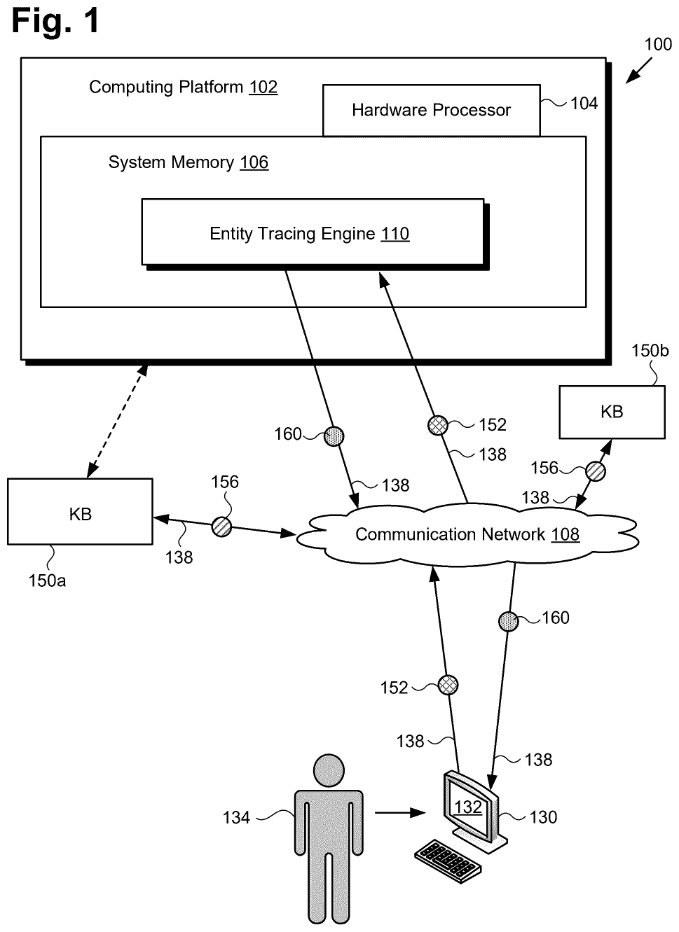

FIG. 1 shows a diagram of an exemplary system for performing ML model-based entity tracing, according to one implementation. As shown in FIG. 1, system 100 includes computing platform 102 having hardware processor 104, and system memory 106 implemented as a computer-readable non-transitory storage medium. According to the present exemplary implementation, system memory 106 stores entity tracing engine 110.

As further shown in FIG. 1, system 100 is implemented within a use environment including communication network 108 and user system 130 utilized by user 134 and including display 132. In addition, the exemplary use environment shown in FIG. 1 further includes content 152, one or more KBs 150a and 150b (hereinafter “KB(s) 150a/150b”), one or more KB entries 156, and output 160 identifying content 152, at least one entity mapping and a relevance score for the at least one entity mapping relative content 152 (entity mapping and relevance score not depicted in FIG. 1). Also shown in FIG. 1 are network communication links 138 interactively connecting user system 130 and KB(s) 150a/150b with system 100 via communication network 108.

It is noted that although FIG. 1 depicts two KB(s) 150a/150b, that representation is merely exemplary. In other implementations, KB(s) 150a/150b may correspond to a single KB (e.g., only one KB 150a, only one KB 150b, or a single KB including a combination of KB 150a and KB 150b), or to more than two KBs accessible by system 100 over communication network 108, which may be a packet-switched network, for example, such as the Internet. It is further noted that although system 100 may be communicatively coupled to one or more of KB(s) 150a/150b via communication network 108 and network communication links 138, as shown in FIG. 1, in some implementations, one or more of KB(s) 150a/150b may be directly accessible by system 100, or may be integrated with system 100 and stored in system memory 106.

It is also noted that, although the present application refers to entity tracing engine 110 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

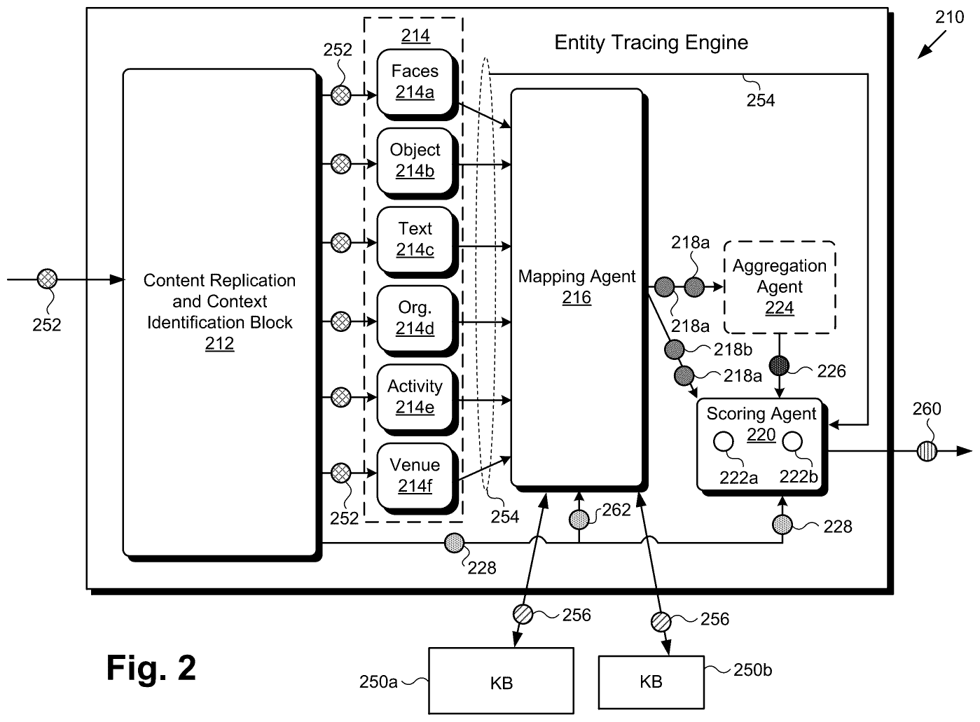

Moreover, although FIG. 1 depicts entity tracing engine 110 as being stored in its entirety in system memory 106, that representation is also provided merely as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. Thus, it is to be understood that various features of entity tracing engine 110, such as one or more of the features described below by reference to FIG. 2, may be stored and executed using the distributed memory and processor resources of system 100.

Hardware processor 104 may include multiple hardware processing units, such as one or more central processing units, one or more graphics processing units, and one or more tensor processing units, one or more field-programmable gate arrays (FPGAs), custom hardware for ML training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs from system memory 106, while a GPU may be implemented to reduce the processing overhead of the CPU by performing computationally intensive graphics or other processing tasks. A TPU is an application-specific integrated circuit (ASIC) configured specifically for artificial intelligence applications such as ML modeling.

In some implementations, computing platform 102 may include one or more web servers, accessible over a packet-switched network such as the Internet, for example. Alternatively, computing platform 102 may include one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth®, for instance to communicate with user system 130. Furthermore, in some implementations, system 100 may be implemented virtually, such as in a data center. For example, in some implementations, system 100 may be implemented in software, or as virtual machines. Moreover, in some implementations, system 100 may be configured to communicate via a high-speed network suitable for high performance computing (HPC). Thus, in some implementations, communication network 108 may be or include a 10 GigE network or an Infiniband network, for example.

According to the implementation shown by FIG. 1, user 134 may utilize user system 130 to interact with system 100 over communication network 108. Although user system 130 is shown as a desktop computer in FIG. 1, that representation is also provided merely as an example. More generally, user system 130 may be any suitable mobile or stationary computing device or system that implements data processing capabilities sufficient to provide a user interface, support connections to communication network 108, and implement the functionality ascribed to user system 130 herein. For example, in other implementations, user system 130 may take the form of a laptop computer, tablet computer, smartphone, or a virtual reality (VR) device, for example, providing display 132. In other implementations, user system 130 may be a peripheral device of system 100 in the form of a “dumb terminal.” In those implementations, user system 130 may be controlled by hardware processor 104 of computing platform 102.

It is noted that, in various implementations, content 152 may include one or more of an image, video, audio, or text. For example, in some use cases content 152 may be an audio-visual content file or streaming audio-visual content including audio, such as dialog or other speech, video including images and text, and metadata, for example. Moreover, in some use cases, content 152 may simply be text. Exemplary content included in content 152 may include one or more of sports content, television (TV) programming content, movie content, advertising content, or video game content.

Moreover, in some implementations, content 152 may be or include digital representations of persons, fictional characters, locations, objects, and identifiers such as brands and logos, for example, which populate a VR, augmented reality (AR), or mixed reality (MR) environment. In those implementations, content 152 may depict virtual worlds that can be experienced by any number of users synchronously and persistently, while providing continuity of data such as personal identity, user history, entitlements, possessions, payments, and the like. Moreover, in some implementations, content 152 may be or include digital content that is a hybrid of traditional audio-visual and fully immersive VR/AR/MR experiences, such as interactive video.

It is further noted that output 160, when generated using entity tracing engine 110, may be stored in system memory 106, may be copied to non-volatile storage, or may be stored in system memory 106 and copied to non-volatile storage. Alternatively, or in addition, as shown in FIG. 1, in some implementations, output 160 may be transmitted via communication network 108 to user system 130, and in some implementations may be rendered on display 132. Display 132 may take the form of a liquid crystal display (LCD), a light-emitting diode (LED) display, an organic light-emitting diode (OLED) display, a quantum dot (QD) display, or any other suitable display screen that performs a physical transformation of signals to light. Furthermore, display 132 may be physically integrated with user system 130 or may be communicatively coupled to but physically separate from user system 130. For example, where user system 130 is implemented as a smartphone, laptop computer, tablet computer, or a VR device, display 132 will typically be integrated with user system 130. By contrast, where user system 130 is implemented as a desktop computer, display 132 may take the form of a monitor separate from user system 130 in the form of a computer tower.

FIG. 2 shows exemplary entity tracing engine 210 suitable for execution by hardware processor 104 of system 100, in FIG. 1, according to one implementation. As shown in FIG. 2, entity tracing engine 210 may include mapping agent 216 implemented as a trained ML model in the form of an LLM or multimodal foundation model, for example, scoring agent 220 implemented as another trained ML model in the form of an LLM or multimodal foundation model, for example, and optional aggregation agent 224 implemented as yet another ML model in the form of an LLM or multimodal foundation model, for example. In addition, FIG. 2 shows content 252 received as an input to entity tracing engine 210, and output 260 provided by entity tracing engine 210. Also shown in FIG. 2 are one or more KBs 250a and 250b (hereinafter “KB(s) 250a/250b”) and one or more KB entries 256.

It is noted that in some implementations, one or more of mapping agent 216, scoring agent 220 and optional aggregation agent 224 may be configured to perform one or more of zero-shot learning or few-shot learning. That is to say, one or more of mapping agent 216, scoring agent 220 and optional aggregation agent 224 may be implemented using a respective LLM or multimodal foundation model configured to perform one or more of zero-shot learning or few-shot learning.

As further shown in FIG. 2, in addition to mapping agent 216, scoring agent 220 and optional aggregation agent 224, entity tracing engine 210 may also include content replication and context identification module 212, and one or more feature analyzer modules 214 (hereinafter “feature analyzer module(s) 214”). FIG. 2 further includes one or more entities 254 identified by feature analyzer module(s) 214 as being represented in content 152/252, entity mappings 218a and 218b provided by mapping agent 216, relevance scores 222a and 222b for respective entity mappings 218a and 218b determined by scoring agent 220, optional aggregated entity mappings 226 identified by optional aggregation agent 224, and optional context 228 identified using content replication and context identification module 212. Moreover, and as also shown in FIG. 2, feature analyzer module(s) 214 may include one or more of facial recognition module 214a, object recognition module 214b, text analysis module 214c, brand, logo, or organization recognition module 214d (hereinafter “organization recognition module 214d”), activity recognition module 214e, and venue recognition module 214f.

It is noted that the specific modules shown to be included among feature analyzer module(s) 214 are merely exemplary, and in other implementations, feature analyzer module(s) 214 may include more, or fewer, modules than facial recognition module 214a, object recognition module 214b, text analysis module 214c, organization recognition module 214d, activity recognition module 214e, and venue recognition module 214f (e.g., any one of modules 214a-214f may be omitted or more than one of a specific module of modules 214a-214f may be included). Moreover, in other implementations, feature analyzer module(s) 214 may include one or more modules other than one or more of facial recognition module 214a, object recognition module 214b, text analysis module 214c, organization recognition module 214d, activity recognition module 214e, and venue recognition module 214f.

For example, in some implementations, feature analyzer module(s) 214 may include a named entity recognition module, a topic recognition module including an ML model trained to identify specific text properties, such as distinguishing between an interview and a news digest, for example, or both a named entity recognition module and a topic recognition module. It is further noted that, in some implementations, it may be advantageous or desirable to implement some or all of feature analyzer module(s) 214 as respectively trained ML models. Thus, in those implementations, facial recognition module 214a may be an ML model specifically trained to perform facial recognition, object recognition module 214b may be another ML model specifically trained to perform object recognition, text analysis module 214c may be yet another ML model specifically trained to perform text analysis, and so forth.

Content 252, output 260, KB(s) 250a/250b and one or more KB entries 256 correspond respectively in general to content 152, output 160, KB(s) 150a/150b and one or more KB entries 156, in FIG. 1. As a result, content 252, output 260, KB(s) 250a/250b and one or more KB entries 256 may share any of the characteristics attributed to respective content 152, output 160, KB(s) 150a/150b and one or more KB entries 156 by the present disclosure, and vice versa. Moreover, like KB(s) 150a/150b, in some implementations, one or more of KB(s) 250a/250b may be stored in system memory 106 of system 100, while in some implementations, one or more of KB(s) 250a/250b may be directly accessible to system 100 or accessible to system 100 via communication network 108, which may be the Internet, for example.

Entity tracing engine 210, in FIG. 2, corresponds in general to entity tracing engine 110, in FIG. 1, and those corresponding features may share any of the characteristics attributed to either corresponding feature by the present disclosure. Thus, like entity tracing engine 210, entity tracing engine 110 may include features corresponding respectively to content replication and context identification module 212, feature analyzer module(s) 214, mapping agent 216, scoring agent 220, and optional aggregation agent 224.

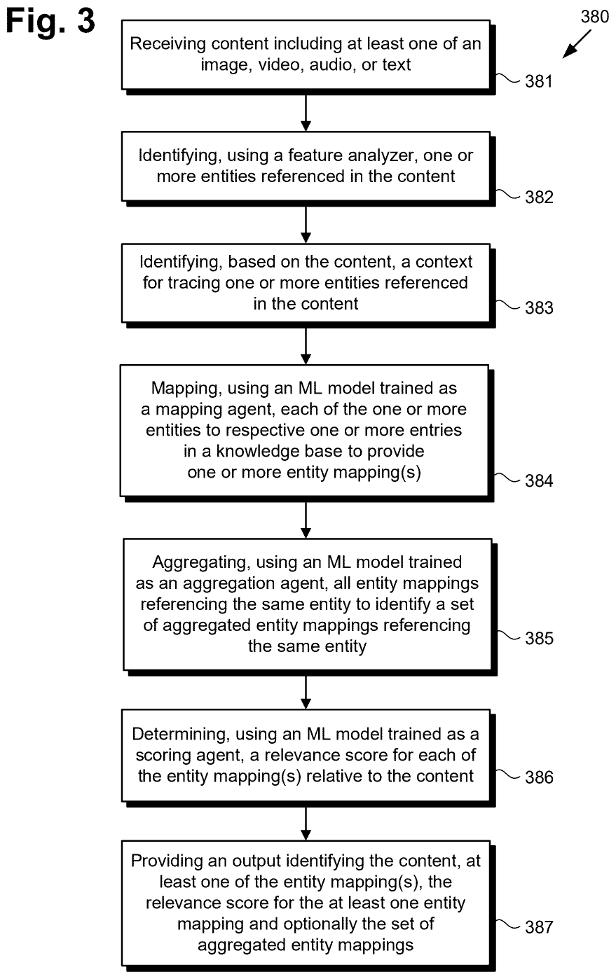

The functionality of entity tracing engine 110/210 will be further described by reference to FIG. 3. FIG. 3 shows flowchart 380 presenting an exemplary method for performing ML model-based entity tracing, according to one implementation. With respect to the method outlined in FIG. 3, it is noted that certain details and features have been left out of flowchart 380 in order not to obscure the discussion of the inventive features in the present application.

Referring to FIG. 3 in combination with FIGS. 1 and 2, flowchart 380 includes receiving content 152/252 including at least one of an image, video, audio, or text (action 381). For example, and as noted above, in some use cases content 152/252 may be an audio-visual content file or streaming audio-visual content including audio, such as dialog or other speech, video including images and text, and metadata. Moreover, in some use cases, content 152/252 may simply be text. Exemplary content included in content 152/252 may include one or more of sports content, TV programming content, movie content, advertising content, or video game content.

Moreover, and as also noted above, in some implementations content 152/252 may be or include digital representations of persons, fictional characters, locations, objects, and identifiers such as brands and logos, for example, which populate a VR, AR, or MR environment. In those implementations, content 152/252 may depict virtual worlds that can be experienced by any number of users synchronously and persistently, while providing continuity of data such as personal identity, user history, entitlements, possessions, payments, and the like. Moreover, in some implementations, content 152/252 may be or include digital content that is a hybrid of traditional audio-visual and fully immersive VR/AR/MR experiences, such as interactive video.

Content 152/252 may be received, in action 381, by entity tracing engine 110/210, executed by hardware processor 104 of system 100. Moreover, and as shown by FIG. 1, in some implementations content 152/252 may be received from user system 130, via communication network 108 and network communication links 138. Alternatively, content 152/252 may be received from a third party source (not shown in FIG. 1), or may be stored in system memory 106.

Continuing to refer to FIG. 3 in combination with FIGS. 1 and 2, flowchart 380 further includes identifying, using feature analyzer module(s) 214 one or more entities 254 represented in content 152/252 (action 382). As noted above, one or more entities 254 may be persons, such as celebrities or athletes, organizations, such as sports teams or companies, logos or brands and venues, to name a few examples. In some implementations, one or more of the analyzer(s) included among feature analyzer module(s) 214 may be utilized in parallel to detect and identify different types of entities 254 referenced in content 152/252 substantially concurrently. In those implementations, content 152/252 may be received in action 381 by content replication and context identification module 212 of entity tracing engine 110/210, and may be replicated by content replication and context identification module 212 to provide a copy of content 152/252 to feature analyzer module(s) 214 substantially concurrently. Action 383 may be performed by entity tracing engine 110/210, executed by hardware processor 104 of system 100, and using one or more of feature analyzer module(s) 214.

Facial recognition module 214a may be used by entity tracing engine 110/210 to identify persons depicted in content 152/252. For example, facial recognition module 214a may identify one or more actors, characters, athletes, or celebrities appearing in content 152/252 as one or more entities 254 referenced in content 152/252.

Object recognition module 214b may be used by entity tracing engine 110/210 to identify objects depicted in content 152/252. For example, object recognition module 214b may identify one or more vehicles, clothing, structures, or sports gear appearing in content 152/252 as one or more entities 254 referenced in content 152/252.

Text analysis module 214c may be used by entity tracing engine 110/210 to interpret text or speech included in content 152/252. For example, text analysis module 214c may be configured to convert dialog, such as a conversation, or other speech included in content 152/252 into text, and to analyze the text to identify the subject matter of the speech based on trained deep learning. Alternatively, or in addition, text analysis module 214c may employ optical character recognition (OCR) to identify signage or text overlays appearing in content 152/252 as corresponding to one or more entities 254 referenced in content 152/252.

Organization recognition module 214d may be used by entity tracing engine 110/210 to identify logos, brands, or organizations appearing in content 152/252 as one or more entities 254 referenced in content 152/252. For example, where content 152/252 includes sports content, organization recognition module 214d may identify a sporting federation or team logos appearing in content 152/252.

Activity recognition module 214e may be used by entity tracing engine 110/210 to identify action depicted in content 152/252. For example, activity recognition module 214e may identifying interaction, such as handshakes, hugs, or other physical manifestations of affection or conflict, amongst entities appearing in content 152/252.

Venue recognition module 214f may be used by entity tracing engine 110/210 to identify locations depicted in content 152/252. For example, venue recognition module 214f may identify iconic locations, such as the Eiffel Tower or Empire State Building, for example, or the stadium or arena in which a sporting event is being played as one or more entities 254 referenced in content 152/252.

It is noted that, in some implementations, all of feature analyzer module(s) 214 may be used to identify entities 254 in content 152/252 in parallel and substantially concurrently. However, in some implementations it may be advantageous or desirable to use some, but not all of feature analyzer module(s) 214 to identify one or more entities 254 referenced in content 152/252. For example, where content includes movie or TV programming content, facial recognition module 214a and text analysis module 214c may be considered to be very important for identifying one or more entities 254, but organization recognition module 214d may be considered to be less important. In that instance, use of organization recognition module 214d may be omitted during action 383. As another example, where content 152/252 includes audio but omits video or still images, text analysis module 214c may be considered to be very important for identifying one or more entities 254, but facial recognition module 214a and object recognition module 214b may be considered to be less important. And so forth.

Continuing to refer to FIG. 3 in combination with FIGS. 1 and 2, in some implementations, flowchart 380 may further include identifying, based on content 152/252, context 228 for tracing one or more entities referenced in content 152/252 (action 383). It is noted that action 383 is, in principle, optional, and in some implementations may be omitted from the method outlined by flowchart 380. In those implementations, the aggregating performed in optional action 385 described below may be omitted as well.

The motivation for including optional action 383 in the method outlined by flowchart 380 is that some state-of-the-art LLMs and multimodal foundation models have limited context input capacity. As a result large textual content can be overwhelming, and trained ML models included in content replication and context identification module 212 can be used summarize content 152/252 as context 228 in a more manageable format, such as condensed text or an internal vector representation that can be used by mapping agent 216 to perform the mapping described below by reference to action 384, as well as by scoring agent 220 to determine the relevance score for each mapped entity in action 386. It is noted that even if an LLM or multimodal foundation model were to be able to handle input of unlimited size, it may still be impractical to feed all information for each instance of content 152/252 due to resource and time constraints.

In implementations in which optional action 383 is included in the method outlined by flowchart 380, context 228 may be identified by entity tracing engine 110/210, executed by hardware processor 104 of system 100, and using content replication and context identification module 212. It is noted that in implementations in which action 383 is omitted from the method outlined by flowchart 380, action 384 described below may follow directly from action 382.

Continuing to refer to FIG. 3 in combination with FIGS. 1 and 2, flowchart 380 further includes mapping, using the ML model trained as mapping agent 216, each of one or more entities 254 to respective one or more entries 156/256 in one or more of KB(s) 150a/150b/250a/250b to provide one or more entity mappings 218a/218b (action 384). As noted above, examples of KB(s) 150a/150b/250a/250b may include WIKIDATA®, the GOOGLE® Knowledge Graph, and the ASSOCIATED PRESS®, to name a few.

As noted above by reference to FIG. 2, in some implementations mapping agent 216 may be implemented as a trained ML model in the form of an LLM or multimodal foundation model, for example. Mapping agent 216 may be trained using one or more human-supervised datasets, for instance, thereby enabling mapping agent 216 to be fine-tuned for any domain based on domain-specific knowledge. Moreover, and as also noted above, in some implementations mapping agent 216 may be configured to perform one or more of zero-shot learning or few-shot learning. That is to say, in some implementations mapping agent 216 may be implemented using an LLM or multimodal foundation model configured to perform one or more of zero-shot learning or few-shot learning.

Where one of one or more entities 254 is identified in action 382 as a person appearing in content 152/252, such as an actor, athlete, or celebrity, for example, action 384 may include searching KB(s) 150a/150b/250a/250b to confirm that the identified actor, athlete, or celebrity is a real person. Moreover, where one of one or more entities 254 is identified as a sports federation with which the identified actor, athlete, or celebrity is affiliated, action 384 may include searching KB(s) 150a/150b/250a/250b to determine whether the identified actor, athlete, or celebrity has a connection to that sports federation and its sport according to one or more entries in KB(s) 150a/150b/250a/250b.

It is noted that the exemplary use case described above in which a person identified in content 152/252 is confirmed to be a real person is merely provided in the interests of conceptual clarity. In various implementations, one or more entities 254 may be identified as a fictional character, such as an animated character, superhero, or dramatis personae, for example. In those implementations, action 384 may include confirming that the identified fictional character has an acknowledged persona.

It is noted that in some use cases, the same name may be shared by several different real people. For example, “Name A” may correspond to an athlete and a pop singer having entries in KB(s) 150a/150b/250a/250b. In those instances, the KB entries that most closely agrees with other entities referenced in content 152/252 that are related to one or the other alternative entity sharing the same name may be relied upon. For example, if the person identified as “Name A” is related to other entities associated with sport but not associated with pop music, the entity may be identified as “athlete Name A” rather than “pop singer Name A.”

Each of entity mappings 218a and 218b may include the identity of the respective entity mapped by entity mapping 218a or 218b, an entity type of that entity, and a KB address of a KB entry referencing the entity. For example, an entity mapped by mapping agent 216 as active cricket player John Smith may include his identity (John Smith (Cricket Player)), his entity type (Person (Active Athlete)) and the KB address of at least one KB entry referencing John Smith. Mapping, using mapping agent 216, each of one or more entities 254 to respective one or more entries 156/256 in one or more of KB(s) 150a/150b/250a/250b to provide one or more entity mappings 218a/218b, in action 384, may be performed by entity tracing engine 110/210, executed by hardware processor 104 of system 100.

Continuing to refer to FIG. 3 in combination with FIGS. 1 and 2, in some implementations, flowchart 380 may further include aggregating, using another ML model trained as aggregation agent 224, all entity mappings of entity mappings 218a and 218b referencing the same entity to identify set of aggregated entity mappings 226 referencing the same entity (action 385). It is noted that action 385 is, like action 383 described above, is in principle optional, and in some implementations may be omitted from the method outlined by flowchart 380.

As noted above by reference to action 383, some state-of-the-art LLMs and multimodal foundation models have limited input capacity. As a result large content inputs can be overwhelming, and it may be advantageous or desirable to perform actions 382 and 384, or actions 382, 383 and 384 on a per entity basis, rather than performing those actions concurrently on all entities referenced in content 152/252. For example, where content 152/252 references two athlete entities “Athlete A” and “Athlete B,” context 228 identified in action 383 may specify that Athlete A is to be the subject of the identification performed using feature analyzer module(s) 214 in action 382, as well as the subject of the mapping performed in action 384. Once actions 382 and 384, or actions 382, 383 and 384 have been performed for “Athlete A,” those actions may be performed for “Athlete B,” and so forth, until all entities referenced in content 152/252 and iteratively specified by context 228 have undergone mapping in action 384.

Regarding the entity “Athlete A,” once all entities referenced in content 152/252 and iteratively specified by context 228, e.g., first “Athlete A” and then “Athlete B,” have undergone mapping in action 384 on a per entity basis, all entity mappings for “Athlete A,” as well as all entity mappings for “Athlete B” that also reference “Athlete A,” are aggregated in action 385 as aggregated entity mappings 226 for “Athlete A” using aggregation agent 224. Similarly, all entity mappings for “Athlete B,” as well as all entity mappings for “Athlete A” that also reference “Athlete B,” are aggregated in action 385 as aggregated entity mappings 226 for “Athlete B” using aggregation agent 224.

As noted above by reference to FIG. 2, in some implementations aggregation agent 224 may be implemented as a trained ML model in the form of an LLM or multimodal foundation model, for example. Aggregation agent 224 may be trained using one or more human-supervised datasets, for instance, thereby enabling aggregation agent 224 to be fine-tuned for any domain based on domain-specific knowledge. Moreover, and as also noted above, in some implementations aggregation agent 224 may be configured to perform one or more of zero-shot learning or few-shot learning. That is to say, in some implementations aggregation agent 224 may be implemented using an LLM or multimodal foundation model configured to perform one or more of zero-shot learning or few-shot learning.

In implementations in which optional action 385 is included in the method outlined by flowchart 380, action 385 may be performed by entity tracing engine 110/210, executed by hardware processor 104 of system 100, and using aggregation agent 224. It is noted that in implementations in which action 385 is omitted from the method outlined by flowchart 380, action 386 described below may follow directly from action 384.

Continuing to refer to FIG. 3 in combination with FIGS. 1 and 2, flowchart 380 further includes determining, using the ML model trained as scoring agent 220, respective relevance scores 222a and 222b for each of one or more entity mappings 218a and 218b relative to content 152/252 (action 386). As noted above, the relevance score of a mapped entity may depend on the number of times that the same entity is referenced in a piece of media content, the number of media modalities used to reference that same entity in the media content, or both. Thus, an entity referenced multiple times may be predicted to be more relevant, i.e., have a higher relevance score, relative to the media content referencing that entity, than another entity referenced fewer times. Alternatively, or in addition, an entity referenced using multiple media modalities, e.g., video, audio, text and the like, may be predicted to be more relevant, i.e., have a higher relevance score, relative to the media content referencing that entity, than another entity referenced using fewer media modalities. As another alternative, or in addition, the relevance score of a mapped entity may be determined using the context of the content in which the entity is referenced, as that context is understood by scoring agent 220.

As noted above by reference to FIG. 2, in some implementations scoring agent 220 may be implemented as a trained ML model in the form of an LLM or multimodal foundation model, for example. Scoring agent 220 may be trained using one or more human-supervised datasets. Moreover, and as also noted above, in some implementations scoring agent 220 may be configured to perform one or more of zero-shot learning or few-shot learning. That is to say, in some implementations scoring agent 20 may be implemented using an LLM or multimodal foundation model configured to perform one or more of zero-shot learning or few-shot learning. Determining respective relevance scores 222a and 222b for each of one or more entity mappings 218a and 218b relative to content 152/252, in action 386, may be performed by entity tracing engine 110/210, executed by hardware processor 104 of system 100, and using scoring agent 220.

Continuing to refer to FIG. 3 in combination with FIGS. 1 and 2, flowchart 380 further includes providing output 160/260 identifying content 152/252, at least one of one or more entity mappings 218a/218b, and relevance score 222a/222b for the at least one of one or more entity mappings 218a/218b (action 387). It is noted that in use cases in which optional aggregation agent 224 is used to identify set of aggregated entity mappings 226 in optional action 385, the output provided in action 387 may further identify set of aggregated entity mappings 226. As shown in FIG. 2, output 160/260 may be provided by entity tracing engine 110/210, executed by hardware processor 104 of system 100.

As noted above, in some use cases, output 160/260 may be provided by entity tracing engine 110/210 for storage in system memory 106, may be copied to non-volatile storage, or may be stored in system memory 106 and copied to non-volatile storage. Alternatively, or in addition, and as also noted above, output 160/260 may be transmitted via communication network 108 to user system 130 including display 132. Although not included in flowchart 380, in some implementations in which output 160/260 is provided to user system 130, the present method can include rendering output 160/260 on display 132 of user system 130. As noted above, display 132 may be implemented as an LCD, an LED display, an OLED display, or a QD display, to name a few examples.

It is noted that, in some implementations, user system 130 including display 132 may be integrated with system 100 such that display 132 may be controlled by hardware processor 104 of computing platform 102. In other implementations, as noted above, entity tracing engine 110/210 may be stored on a computer-readable non-transitory storage medium, and may be accessible to the hardware processing resources of user system 130. In those implementations, the rendering of output 160/260 on display 132 may be performed by entity tracing engine 110/210, executed either by hardware processor 104 of computing platform 102, or by a hardware processor of user system 130.

Referring back to FIG. 2, it is noted that although the implementations described by reference to that figure above characterize some or all of feature analyzer module(s) 214 to be utilized in parallel, and substantially concurrently, those implementations are merely exemplary. In some use cases, it may be advantageous or desirable to use less than all of feature analyzer module(s) 214, and to use them sequentially rather and concurrently, based on context 228 for example. That is to say, if the results of utilizing a few of feature analyzer module(s) 214 are anticipated to be sufficient to trace the entities referenced in content 152/252 based on context 228, some of feature analyzer module(s) 214 would not need to run, thereby advantageously saving time.

With respect to the method outlined by flowchart 380 and described above, it is noted that actions 381, 382, 384, 386 and 387, or actions 381, 382, 383, 384, 386 and 387, or actions 381, 382, 384, 385, 386 and 387, or actions 381, 382, 383, 384, 385, 386 and 387, may be performed in an automated process from which human participation may be omitted.

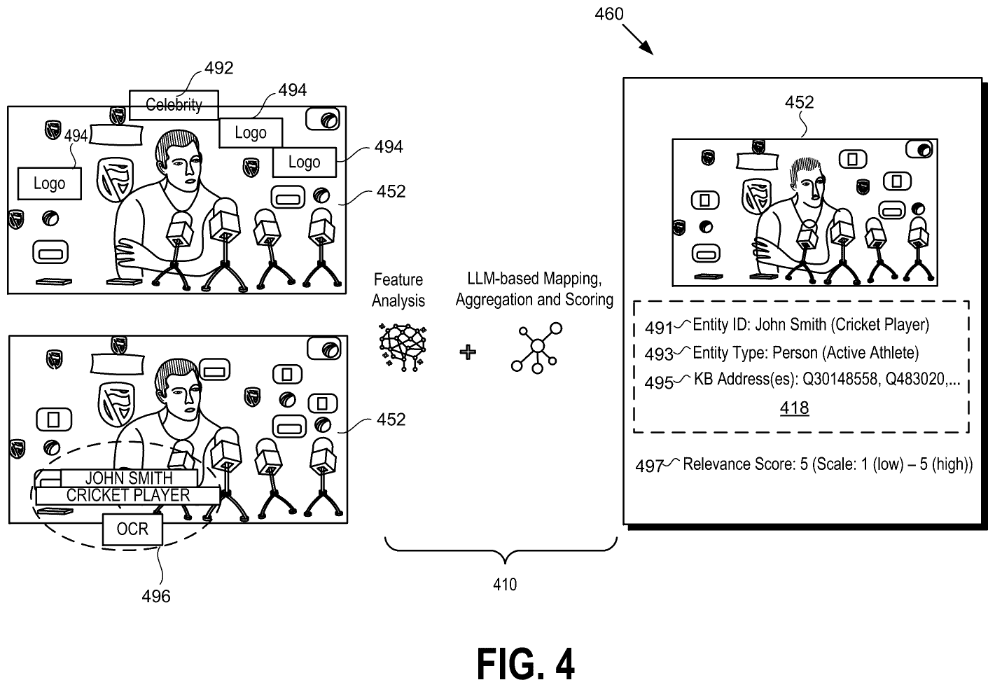

FIG. 4 shows a diagram depicting features detected in audio-visual content and used to trace an entity identified as John Smith, a cricket player, according to one exemplary implementation. FIG. 4 shows content 452 including entities identified as celebrity athlete 492 and sports logo 494, as well as text 496. Also shown in FIG. 4 is output 460 including entity mapping 418, provided by entity tracing engine 410 based on content 452.

It is noted that content 452, output 460 and entity mapping 418 correspond respectively in general to content 152/252, output 160/260 and either of entity mappings 218a or 218b shown variously in FIGS. 1 and 2. Thus, content 452, output 460 and entity mapping 418 may share any of the characteristics attributed to respective content 152/252, output 160/260 and entity mappings 218a and 218b by the present disclosure, and vice versa.

According to the example shown in FIG. 4, content 152/252/452 includes an entity identified by facial recognition module 214a as celebrity athlete 492, an entity identified by organization recognition module 214d as sports logo 494, and text 496 detected and interpreted by text analysis module 214c. In addition to text 496, text analysis module 214c may interpret the speech uttered by celebrity athlete entity 492 as being about a specific sport, i.e., cricket in the example shown by FIG. 4.

As further shown in FIG. 4, output 460 includes content 452, entity mapping 418 for celebrity athlete entity 492 John Smith, and relevance score 497 for entity mapping 418 relative to content 452. Moreover, entity mapping 418 includes entity identity 491 of the entity mapped by entity mapping 418, i.e., John Smith (Cricket Player), his entity type 493, i.e., Person (Active Athlete), and the KB address or addresses 495 of KB entries referencing John Smith.

Thus, the present application discloses systems and methods for performing ML model-based entity tracing that advance the state-of-the-art in several ways. For example, in domains where conventional rules would require extensive manual tuning, the LLM-based or multimodal foundation model-based approach disclosed in the present application produces accurate results with minimal additional effort. Furthermore, the maintenance of the system disclosed herein based on LLMs or multimodal foundation models is significantly easier because an LLM-based or multimodal foundation model-based approach allows for straightforward retraining and updating of the model, ensuring that the system remains accurate and effective over time. Additionally, the adaptability of the LLM-based and multimodal foundation model-based systems disclosed in the present application is unparalleled. Once trained on a particular domain, these models can be readily applied to other domains with minimal additional effort, making them an ideal solution for organizations with diverse needs.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory;
an entity tracing engine stored in the system memory, the entity tracing engine including a first machine learning (ML) model trained as a mapping agent and a second ML model trained as a scoring agent;
the hardware processor configured to execute the entity tracing engine to:
receive content including at least one of an image, a video, an audio, or a text;
identify, using a feature analyzer, one or more entities referenced in the content;
map, using the first ML model trained as the mapping agent, each of the one or more entities to respective one or more entries in a knowledge base to provide one or more entity mappings;
determine, using the second ML model trained as the scoring agent, a relevance score for each of the one or more entity mappings relative to the content; and
provide an output identifying the content, at least one of the one or more entity mappings and the relevance score for the at least one of the one or more entity mappings.

2. The system of claim 1, wherein the mapping agent is implemented using a first large-language model (LLM) or a first multimodal foundation model, and wherein the scoring agent is implemented using a second LLM or a second multimodal foundation model.

3. The system of claim 2, wherein at least the first LLM or the first multimodal foundation model is configured to perform one or more of zero-shot learning or few-shot learning.

4. The system of claim 1, wherein the hardware processor is further configured to execute the entity tracing engine to:
identify, based on the content, a context for tracing the one or more entities;
wherein each of the mapping and the determining uses the context.

5. The system of claim 4, wherein the one or more entities include a plurality of entities, the one or more entity mappings include a plurality of entity mappings, and wherein the hardware processor is further configured to execute the entity tracing engine to:
before the determining aggregate, using a third ML model trained as an aggregation agent, all entity mappings of the plurality of entity mappings referencing a same entity of the plurality of entities to identify a set of aggregated entity mappings referencing the same entity;
wherein the output further identifies the set of aggregated entity mappings.

6. The system of claim 1, wherein the aggregation agent is implemented using a third LLM or a third multimodal foundation model.

7. The system of claim 1, wherein each of the one or more entity mappings includes an identity of an entity mapped by the entity mapping, an entity type of the entity, and a knowledge base address of a knowledge base entry referencing the entity.

8. The system of claim 1, wherein the feature analyzer includes at least one of a facial recognition module, an object recognition module, an activity recognition module, or a text analysis module configured to analyze text and speech included in the content.

9. The system of claim 1, wherein the feature analyzer includes at least one of an organization recognition module or a venue recognition module.

10. The system of claim 1, wherein the content comprises at least one of sports content, television programming content, movie content, advertising content, or video game content.

11. A method for use by a system including a computing platform having a hardware processor and a system memory storing an entity tracing engine, the entity tracing engine including a first machine learning (ML) model trained as a mapping agent and a second ML model trained as a scoring agent, the method comprising:
receiving, by the entity tracing engine executed by the hardware processor, content including at least one of an image, a video, an audio, or a text;
identifying, by the entity tracing engine executed by the hardware processor and using a feature analyzer, one or more entities referenced in the content;
mapping, by the entity tracing engine executed by the hardware processor and using the first ML model trained as the mapping agent, each of the one or more entities to respective one or more entries in a knowledge base to provide one or more entity mappings;
determining, by the entity tracing engine executed by the hardware processor and using the second ML model trained as the scoring agent, a relevance score for each of the one or more entity mappings relative to the content; and
providing and output, by the entity tracing engine executed by the hardware processor, identifying the content, at least one of the one or more entity mappings and the relevance score for the at least one of the one or more entity mappings.

12. The method of claim 11, wherein the mapping agent is implemented using a first large-language model (LLM) or a first multimodal foundation model, and wherein the scoring agent is implemented using a second LLM or a second multimodal foundation model.

13. The method of claim 12, wherein at least the first LLM or the first multimodal foundation model is configured to perform one or more of zero-shot learning or few-shot learning.

14. The method of claim 11, further comprising:
identifying, by the entity tracing engine executed by the hardware processor based on the content, a context for tracing the one or more entities;
wherein each of the mapping and the determining uses the context.

15. The method of claim 14, wherein the one or more entities include a plurality of entities and wherein the one or more entity mappings include a plurality of entity mappings, the method further comprising:
before the determining, aggregating, by the entity tracing engine executed by the hardware processor using a third ML model trained as an aggregation agent, all entity mappings of the plurality of entity mappings referencing a same entity of the plurality of entities to identify a set of aggregated entity mappings referencing the same entity;
wherein the output further identifies the set of aggregated entity mappings.

16. The method of claim 11, wherein the aggregation agent is implemented using a third LLM or a third multimodal foundation model.

17. The method of claim 11, wherein each of the one or more entity mappings includes an identity of an entity mapped by the entity mapping, an entity type of the entity, and a knowledge base address of a knowledge base entry referencing the entity.

18. The method of claim 11, wherein the feature analyzer includes at least one of a facial recognition module, an object recognition module, an activity recognition module, or a text analysis module configured to analyze text and speech included in the content.

19. The method of claim 11, wherein the feature analyzer includes at least one of an organization recognition module or a venue recognition module.

20. The method of claim 11, wherein the content comprises at least one of sports content, television programming content, movie content, advertising content, or video game content.
